(19) United States
(12) Patent Application Publication
(10) Pub. No.: US 2005/0245228 A1
(43) Pub. Date: Nov. 3, 2005

(54) Portable communication device for supporting multiple communication modes over a common changeable antenna structure

(76) Inventors: Alejandro Candal, Davie, FL (US); David H. Minasi, Ft. Lauderdale, FL (US); Lorenzo A. Ponce De Leon, Lake Worth, FL (US)

Correspondence Address: Scott M. Garrett;Motorola, Inc., Law Department, 8000 West Sunrise Boulevard, Fort Lauderdale, FL, 33322, US

(21) Appl. No.: 10/837,321

(22) Filed: Apr. 29, 2004

(51) Int. Cl. H04K 3/00

(52) U.S. Cl. 455/347; 455/348

(57) ABSTRACT

A portable communication device includes a first communication subsystem (102) and a second communication subsystem (104). The two communication subsystems operate in different frequency bands and use a common antenna structure. The antenna structure includes a fixed antenna element (110) and a retractable antenna (114) that may be electrically coupled to the fixed antenna element when moved to a fully extended position. The retractable antenna changes the impedance characteristics of the antenna structure substantially at the frequency used by the second communication subsystem, so a matching network (108) is switched in or out of the path between the second communication subsystem and the diplexer. A position detecting circuit (116) and switch controller (118) control operating of the matching network (108) depending on the position of the retractable antenna.

### TECHNICAL FIELD

This invention relates in general to portable communication devices, and more particularly to portable communication devices which operate over multiple frequency bands and perform a variety of communication functions.

### BACKGROUND OF THE INVENTION

Portable communication devices are widely used for a variety of communication activity, and are especially prominent in urban and metropolitan regions around the world. Given the variety of communication services available, it is becoming increasingly common to find multi-mode or integrated communication devices that can take advantage of multiple communication services. Such integrated devices eliminate the need for a user to carry multiple single mode communication devices to engage in different communication activities.

While integration provides opportunities to share components, circuits, processors, and other portions of hardware, often the various communication services are simply too dissimilar that separate subsystems are required to support the different communication services. For example, different antennas may be needed if the communication services use substantially different frequency bands, as in cellular phones that have satellite positioning receivers where one antenna is used for cellular phone communication and a different antenna is used to receive the satellite positioning signals. Alternatively, matching circuits may be used between the antenna and the various communication subsystems, and switched in when the respective subsystem is active, and isolated from the other subsystems.

Furthermore, it is common to provide multiple antenna elements for a particular communication activity. For example, it is known to provide a helical antenna element and a retractable whip antenna in cellular phones. When the whip antenna is retracted into the phone, only the helical antenna is active, but when the whip antenna is extended it works in conjunction with the helical antenna. When the two antenna elements are joined, however, the effective characteristics may change sufficiently that the matching parameters may need to be changed. As such, there are schemes described for detecting the position of an antenna element, and switching in or out matching circuitry, depending on the position of the moveable antenna element. Additionally in the prior art there are numerous schemes described for switching in and out matching networks depending on the present frequency band of activity so that the different subsystems can use a common antenna. In the prior art these matching networks are coupled to the antenna, which restricts use of the antenna to one subsystem at a time. Therefore there is a need for a means by which different communication subsystems may use a common antenna at the same time, and where the antenna characteristics may change due to the movement of an antenna element, appropriate matching can still be applied.

### BRIEF DESCRIPTION OF THE DRAWINGS

FIG. 1 shows a block diagram of a portable communication device having multiple communication subsystems that share a common antenna structure having a moveable antenna element in a first position;

FIG. 2 shows a block diagram of a portable communication device having multiple communication subsystems that share a common antenna structure having a moveable antenna element in a second position; and

FIG. 3 shows a mechanical diagram of a portable communication device illustrating the locations of the fixed and moveable antenna elements, in accordance with one embodiment of the invention;

FIG. 4 shows a block schematic diagram of a switchable matching network for use with the invention;

FIG. 5 shows a smith chart plot of the effect of coupling a retractable antenna to a fixed antenna for a satellite positioning frequency band; and

FIG. 6 shows a flow chart diagram for a method of applying a matching circuit to a communication subsystem in accordance with an embodiment of the invention.

### DETAILED DESCRIPTION OF A PREFERRED EMBODIMENT

While the specification concludes with claims defining the features of the invention that are regarded as novel, it is believed that the invention will be better understood from a consideration of the following description in conjunction with the drawing figures, in which like reference numerals are carried forward.

The invention solves the problem of providing multiple communication subsystems in a portable communication device for use with a common antenna structure including a moveable antenna element where the different communication subsystems use different frequency bands and need to use the antenna at the same time as other communication subsystems use the antenna. Access to the antenna is accomplished by providing a diplexer between the communication subsystems and the antenna structure, and providing switchable matching circuits between the diplexer and a given communication subsystem, and a means to change the matching characteristics according to the position of the moveable antenna element.

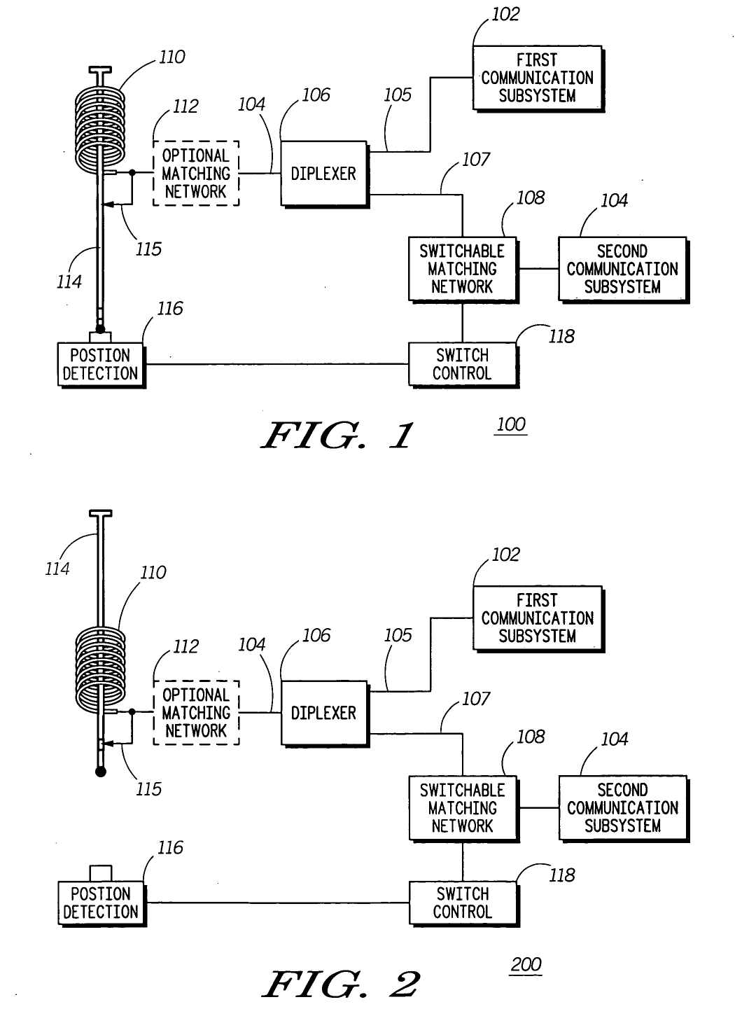

Referring now to FIGS. 1 and 2, which show a block diagram of a portable communication device having multiple communication subsystems that share a common antenna structure having a moveable antenna element in a first position 100, and a second position 200, respectively. The portable communication device includes a first communication subsystem 102 and a second communication subsystem 104. The communication subsystems operate on different radio frequency bands. Each of the communication subsystems provide signal processing for radio frequency communications in accordance with a communication protocol or air interface, including modulation, demodulation, amplification, digitization, digital to analog conversion, and so on, as needed. For example, the first communication subsystem may provide functionality for cellular telephony communication in accordance with the Global Specification for Mobile communication (GSM), as is known in the art. Other examples of possible communication formats that may be supported are code division multiple access (CDMA) communications such as that in accordance with the Personal Communication System (PCS) standard, two way messaging, satellite positioning, and two-way radio communication, to name but a few possible choices. In the preferred embodiment, the first communication subsystem provides communication in accordance with the system sold under the trade name iDEN, and made by Motorola Inc. of Schaumburg, Ill. Further, in accordance with the preferred embodiment, the second communication subsystem is a satellite positioning receiver for receiving satellite positioning signals such as those in accordance with the Global Positioning Satellite (GPS) system. Both of the communication subsystems are operably coupled to a diplexer 106. A diplexer, as is known in the art, includes bandpass filters to isolate the communication subsystems from each other so that they can use the antenna structure at the same time. The first communication subsystem is coupled to the diplexer at a first communication port 105, while the second communication subsystem is coupled to the diplexer at a second communication port 107. The diplexer further comprises an antenna port 109 to operably couple the diplexer to the antenna structure. The antenna structure includes a fixed antenna element 110, which, in the preferred embodiment is a helical antenna element, and a retractable or moveable antenna element 114, such as a whip antenna element. In the preferred embodiment, the whip antenna has a length substantially equal to a quarter of a wavelength of the frequency of operation of the first communication subsystem. A fixed matching network 112 may be disposed between the diplexer and antenna structure, depending on the application. As shown in FIG. 1, the retractable antenna element 114 is in a retracted, or non-extended position, and is not electrically coupled to the antenna structure. In FIG. 2, the retractable antenna is shown in an extended position and is electrically coupled to the antenna structure by a connector 115 which makes contact with a feed point at the base of the retractable antenna element. Thus, when the retractable antenna element is moved from one position to another, the electrical characteristics of the antenna structure change, and depending on the frequency band of interest, different matching circuitry may be needed by one of the communication subsystems. Thus, as shown here, the second communication subsystem is coupled to the diplexer through a switchable matching network 108. Note, though, that the matching network is not in a path common the both communication subsystems, and only affects signals of the second communication subsystem. When the retractable antenna is in one position, the switchable matching network is switched in, and when the retractable antenna is in a second position, the switchable matching network is switched out, or bypassed. To determine the position of the moveable antenna element 114, a position detecting means 116 is used. The position detecting means may be a mechanical switch, or optical position sensor, for example. The position detecting means is operably coupled to a switch control means 118, and provides a switch signal to the switch control means. In response, the switch control means operates the switchable matching network. The switch control means may be implemented with a microprocessor and appropriate instruction code. The signal to the switchable matching network in the preferred embodiment is a digital switch signal, and is used to bias a switch circuit, such as a field effect transistor or (FET) or PIN diode, as is known in the art.

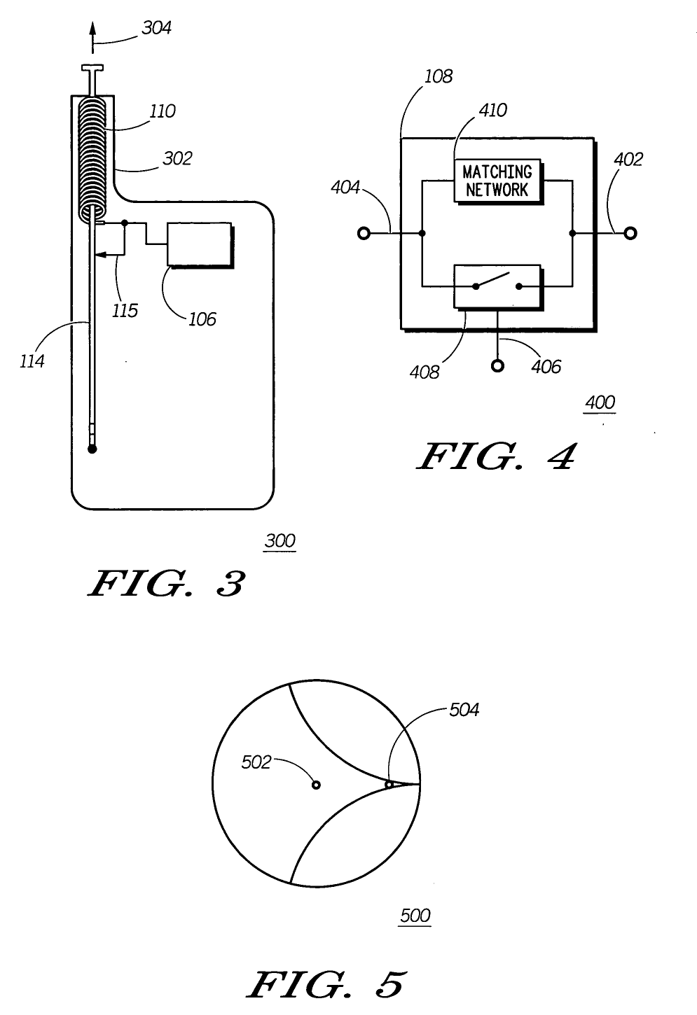

Referring now to FIG. 3, there is shown a mechanical diagram 300 of a portable communication device illustrating the locations of the fixed and moveable antenna elements, in accordance with one embodiment of the invention. The body 301 of the portable communication device includes an antenna boss 302. In the preferred embodiment, the fixed antenna element 110 is a helical antenna element disposed in the antenna boss 302, and the retractable antenna element 114 is oriented so that it is within the helical antenna coaxially along an axis of the helical antenna and is moveable in the direction of arrow 304 to an extended position from the retracted position shown. The antenna structure is coupled to the diplexer 106 and includes the antenna contact 115 for electrically coupling to the retractable antenna when the retractable antenna is move to the extended position. Of course, numerous configuration can be designed where two or more antenna elements may be joined or disjoined, and the particular arrangement shown here is just one example of such a configuration.

Referring now to FIG. 4, there is shown a block schematic diagram 400 of a switchable matching network 108 for use with an embodiment of the invention. The switchable matching network includes a first port 402 for coupling to the communication subsystem, a second port 404 for coupling the diplexer, and a third port 406 for receiving the switch control signal from the switch control means (118). The third port 406 is coupled to an electronic radio frequency (RF) switch 408, which may be a FET or PIN diode switch, as is known. The radio frequency switch is used to bypass a matching network 410. When the retractable antenna is in a first position, the RF switch is closed, bypassing the matching network, and when the retractable antenna is in a second position the RF switch is opened causing signals to pass through the matching network. It is contemplated that there are a variety of switch topologies and switch means that may be equivalently employed, as known in the art. For example, a switch may be employed between a matching network component and an electrical ground reference, rather than as a bypass switch as shown.

Referring now to FIG. 5, there is shown a smith chart diagram 500 showing the frequency response of an antenna structure in accordance with the invention. In the preferred embodiment, the second communication subsystem is a satellite positioning receiver, and receives signals in a substantially different frequency band from the frequency band used by the first communication subsystem. At the frequency of the satellite positioning system signals, i.e. the signals transmitted by the satellites, with only the fixed antenna element coupled to the diplexer, the system is designed with matching impedance 502. When the retractable antenna is extended, and coupled to the fixed antenna element, the frequency response shifts to a different point 504. Thus, to correct the mismatch when the retractable antenna is extended, the matching network 410 is switched in by opening the bypass switch 408, for example.

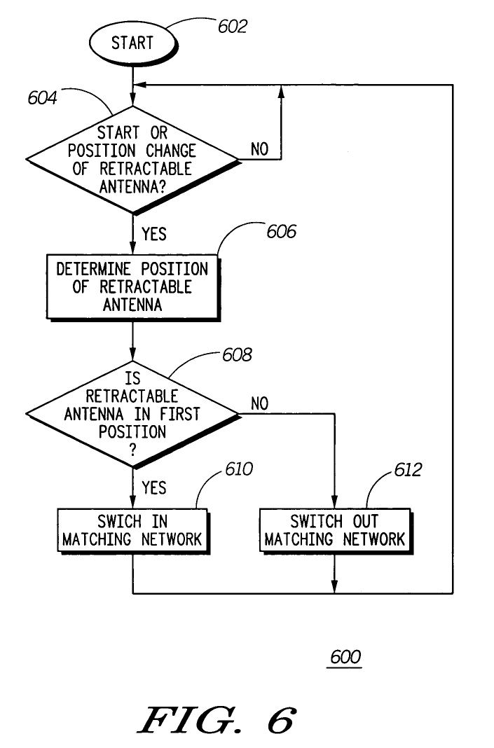

Referring now to FIG. 6, there is shown a flow chart diagram 600 of a method of applying a matching circuit to a communication subsystem in accordance with an embodiment of the invention. At the start 602, the portable communication device is typically powered up. After powering up, the device checks to see if either a power up event or a change in position of the retractable antenna has occurred (604). If not, then the process repeats while the device remains powered up. If the device determines either a power up event or a position change of the retractable antenna has occurred, then the device determines the position of the retractable antenna (606). The device then makes a decision as to the state of the switchable matching network (608). If the retractable antenna is in a first position, then the matching network is switched in (610), meaning signals pass through the matching network. If the retractable antenna is not in the first position, then the matching network is switched out, or bypassed (612). Thereafter the process repeats.

Thus, the invention provides a portable communications device that has a fixed antenna element and a retractable antenna element that can be selectively coupled to the fixed antenna element by changing its position. There are at least two communication subsystems that need to use the antenna, including a first communication subsystem and a second communication subsystem. A diplexer is operably coupled to the fixed antenna element via an antenna port of the diplexer. The diplexer has first and second communication ports as well, for coupling to the first and second communication subsystems, respectively. The device also has a retractable antenna element that is moveable between a first position and a second position. That is, moveable between an extended position, where it is electrically coupled to the fixed antenna element, and a retracted position, where it is accommodated within the device, according to the preferred embodiment. Whenever the retractable antenna is not fully extended, it is not electrically coupled to the fixed antenna element. When the retractable antenna is extended and electrically coupled to the fixed antenna element, it does not substantially change the frequency response of the antenna structure at the frequency of operation of the first communication subsystem. However, because the frequency of operation of the second communication subsystem is substantially different than that of the first communication subsystem, a switchable matching circuit is operably disposed between the second communication subsystem and the second communication port of the diplexer. Operation of the switchable matching circuit is controlled by a switch control circuit in response to a position detecting means. The position detecting means detects the position of the retractable antenna element and provides a switch signal to the switch control circuit. The switch control circuit and position detecting means operate together to switch in the switchable matching circuit between the second communication subsystem and diplexer when the retractable antenna element is in the first position and switch out or bypass the switchable matching circuit when the retractable antenna element is in the second position, or not fully extended. In the preferred embodiment the fixed antenna element is a helical antenna element. The helical antenna element may have a fixed pitch, or it may be a multi-pitch helical antenna element. The first communication subsystem may be a transceiver, as opposed to a receive-only subsystem. In one embodiment of the invention the transceiver supports duplex and half-duplex communication, such as in accordance with communication devices manufactured and sold under the trade name iDEN by Motorola, Inc. It is contemplated that a fixed matching network may be operably disposed between the diplexer and the fixed antenna element. In one embodiment of the invention second communication subsystem is a receiver, such as a satellite positioning receiver for receiving satellite positioning signals. Additionally, it is contemplated that the position detecting means includes a switch which is activated by movement of the retractable antenna element.

It is further contemplated that the use of diplexers may be extended, so that, for example, rather than coupling the second communication subsystem directly to the diplexer, a second diplexer is coupled to the first diplexer at the first diplexer's communication port, and the second diplexer is in turn coupled to a second and a third communication subsystem. Each of these may require access to the antenna at the same time as the first communication subsystem, and each have a switchable matching network disposed between the respective subsystem and the second diplexer.

While the preferred embodiments of the invention have been illustrated and described, it will be clear that the invention is not so limited. Numerous modifications, changes, variations, substitutions and equivalents will occur to those skilled in the art without departing from the spirit and scope of the present invention as defined by the appended claims.

1. A portable communications device, comprising:
a fixed antenna element;
a diplexer operably coupled to the fixed antenna element at an antenna port, and having first and second communication ports;
a first communication subsystem operably coupled to the first communication port of the diplexer and operating in a first frequency band;
a second communication subsystem operably coupled to the second communication port of the diplexer and operating in a second frequency band that is substantially different than the first frequency band;
a switchable matching circuit operably disposed between the second communication subsystem and the second communication port of the diplexer;
a switch control circuit for controlling the switchable matching circuit
a retractable antenna element having a position moveable between a first position and a second position; and
a position detecting means for detecting the position of the retractable antenna element and providing a switch signal to the switch control circuit;
wherein the switch control circuit and position detecting means operate to switch in the switchable matching circuit between the second communication subsystem when the retractable antenna element is in the first position and switch out the switchable matching circuit when the retractable antenna element is in the second position.

2. A portable communication device as defined in claim 1, wherein the fixed antenna element is a helical antenna element.

3. A portable communication device as defined in claim 2, wherein the helical antenna element has a fixed pitch.

4. A portable communication device as defined in claim 2, wherein the helical antenna element is a multi-pitch helical antenna element.

5. A portable communication device as defined in claim 1, wherein the first communication subsystem is a transceiver.

6. A portable communication device as defined in claim 5, wherein the transceiver supports duplex and half-duplex communication.

7. A portable communication device as defined in claim 1, further comprising a fixed matching network operably disposed between the diplexer and the fixed antenna element.

8. A portable communication device as defined in claim 1, wherein the second communication subsystem is a receiver.

9. A portable communication device as defined in claim 8, wherein the receiver is a satellite positioning receiver for receiving satellite positioning signals.

10. A portable communication device as defined in claim 1, wherein the position detecting means comprises a switch which is activated by movement of the retractable antenna element.

11. A method for operating a switchable matching circuit in a portable communication device having a first communication subsystem and a second communication subsystem, the first communication subsystem coupled to a first communication port of a diplexer, the second communication subsystem coupled to a second communication port of the diplexer, the method comprising:
providing simultaneous access to an antenna structure, the antenna structure including a fixed antenna element and a retractable antenna element;
determining a position of the retractable antenna element;
switching a matching network in between the second communication subsystem and the diplexer when the retractable antenna is in a first position; and
bypassing the matching network when the retractable antenna is in a second position.
